(19) United States
(12) Patent Application Publication
(10) Pub. No.: US 2008/0160286 A1
(43) Pub. Date: Jul. 3, 2008

(54) Modified discontinuous glass fibers for use in the formation of thermoplastic fiber-reinforced composite articles

(76) Inventors: Jawed Asrar, Greenwood Village, CO (US); Thomas Burghardt, Parker, CO (US)

Correspondence Address: JOHNS MANVILLE, 10100 WEST UTE AVENUE, PO BOX 625005, LITTLETON, CO, 80162-5005, US

(21) Appl. No.: 11/645,963

(22) Filed: Dec. 27, 2006

(51) Int. Cl. B32B 5/16; D02G 3/18; B29C 45/14; C03C 17/22

(52) U.S. Cl. 428/323; 65/60.1; 428/372; 264/328.17

(57) ABSTRACT

Surface-modified discontinuous glass fibers are provided for incorporation in a thermoplastic matrix to form a fiber-reinforced composite article by injection or compression molding which displays enhanced mechanical properties, including improved tensile strength. Good binding between the discontinuous glass fibers and the thermoplastic matrix is achieved through the presence of finely roughened surfaces on the fibers of nanoparticles of an inorganic material. Such nanoparticles are provided from an alkaline aqueous size composition containing the nanoparticles dispersed therein (as described). The glass fibers are initially provided in continuous form followed by cutting into discontinuous lengths and drying with the retention of the nanoparticles on the surfaces of the fibers. Improved color in the resulting injection or compression molded thermoplastic discontinuous glass fiber-reinforced composite articles is made possible in combination with enhanced mechanical properties.

### FIELD OF THE INVENTION

The subject invention pertains to the formation of improved discontinuous glass fibers for incorporation in a thermoplastic matrix to form a fiber-reinforced composite article by injection or compression molding which displays enhanced mechanical properties. Good binding between the thermoplastic matrix and the glass fiber reinforcement is made possible.

### DESCRIPTION OF RELATED ART

Various binders and sizing compositions are known to improve the handling characteristics of glass fibers.

When discontinuous glass fibers are incorporated in the continuous phase of a thermoplastic polymeric matrix material to serve a reinforcing role it is known to be advantageous that the fibers also bind to some degree to the continuous phase of the matrix material of the resulting fiber-reinforced composite article. Otherwise, various forms of product failure may occur during use. For instance, various coupling agents commonly are being employed to help the glass-fiber reinforcement better attach to the matrix material of the continuous phase. It is also desirable that the formulations that are utilized display minimal color in the final fiber-reinforced composite article.

It has been proposed to prepare an epoxy thermoset resin, which incorporates a woven continuous filament fabric, in which a sizing package including colloidal silica is applied to the woven fabric prior to the incorporation followed by vacuum assisted resin transfer molding. See, for instance, Army Research Laboratory Report No. ARL-TR-3241 (July 2004), and R. E. Jensen, S. H. McKnight, Composites Sci. Tech., Vol. 66, Pages 509 to 521 (2006).

It is an object of the present invention to provide an improved process as well as the resulting product for forming modified discontinuous glass fibers suitable for incorporation in a thermoplastic matrix to form a fiber-reinforced composite by injection or compression molding which displays enhanced mechanical properties, such as improved tensile strength.

It is another object of the present invention to provide an improved process as well as the resulting product for forming a discontinuous glass fiber-reinforced thermoplastic composite article by injection or compression molding which displays enhanced mechanical properties, such as improved tensile strength and impact resistance.

It is another object of the present invention to provide discontinuous fiber-reinforced injection molded or compression molded composite articles which may display improved toughness combined with good color.

It is a further object of the invention to provide injection molded or compression discontinuous fiber-reinforced molded glass fiber-reinforced composite articles which may display good color, improved mechanical properties including improved tensile strength, and a reduced size requirement when compared to a conventional size.

These and other objects of the invention, as well as the scope, nature and utilization of the invention will be apparent to those skilled in the art from the following detailed description.

### SUMMARY OF THE INVENTION

A process, as well as the resulting product, is provided for forming modified discontinuous glass fibers suitable for incorporation in a thermoplastic matrix and the formation of a fiber-reinforced composite article by injection or compression molding which displays enhanced mechanical properties comprising:

(a) adhering nanoparticles of an inorganic material that are dispersed in an alkaline aqueous size composition to the surfaces of glass fibers which are present in continuous form to provide finely roughened surfaces on the continuous glass fibers as the result of the presence of the nanoparticles of the inorganic material,

(b) cutting the continuous glass fibers into discontinuous lengths while retaining the roughened surfaces on the glass fibers as the result of the presence of the nanoparticles of the inorganic material, and

(c) drying said discontinuous glass fibers while retaining said roughened surfaces on said glass fibers.

A process, as well as the resulting product, is provided for forming a discontinuous glass fiber-reinforced thermoplastic composite article comprising:

(a) adhering nanoparticles of an inorganic material that are dispersed in an alkaline aqueous size composition to the surfaces of glass fibers which are present in continuous form to provide finely roughened surfaces on the glass fibers as the result of the presence of the nanoparticles of the inorganic material,

(b) cutting the continuous glass fibers into discontinuous lengths while retaining the roughened surfaces on the glass fibers as the result of the presence of the nanoparticles of the inorganic material,

(c) extruding the discontinuous glass fibers having said finely roughened surfaces together with a thermoplastic wherein the surface-attached nanoparticles of inorganic material serve to promote the secure bonding of the discontinuous glass fibers within the thermoplastic to form a material suitable for molding, and

(d) injection or compression molding said material incorporating the discontinuous glass fibers having the finely roughened surfaces to form a fiber-reinforced thermoplastic composite article which displays enhanced mechanical properties.

### DESCRIPTION OF PREFERRED EMBODIMENTS

The present invention makes possible the efficient formation of quality thermoplastic fiber-reinforced composite articles by injection or compression molding. In accordance with the concept of the present invention, nanoparticles of an inorganic material initially are well dispersed within an alkaline aqueous size composition. The nanoparticles of an inorganic material are relatively inert under the conditions that are encountered in the size composition and commonly possess an average particle size of approximately 3 to 40 nm, preferably approximately 3 to 10 nm. Such particle size can be determined by the use of particle size analysers that are being manufactured by companies such as Malvern of Worcestershire, United Kingdom, Beckman Coulter of Fullerton, Calif., U.S.A., and others. Inorganic nanoparticles displaying a specific surface area 300 m²/g commonly possess an average particle size of approximately 10 nm, and inorganic nanoparticles displaying a specific surface area of 650 m²/g commonly possess an average particle size of approximately 3 nm. In preferred embodiments, the nanoparticles of an inorganic material are provided as substantially amorphous spheres; however, other particle shapes are suitable for use and may have different ratios of surface areas to their sizes.

In preferred embodiments, the nanoparticles of an inorganic material are silica of the specified particle size. Representative colloidal silica nanoparticles for use in the present invention are commercially available from Eka Chemicals, Inc. of Marietta, Ga., U.S.A. under the designation of Bindzil® 830 or from Grace Davison of Columbia, Md., U.S.A. under the Ludox® SM designation. Other representative nanoparticles of an inorganic material suitable for use in the present invention include clays, including montmorillonite-type clays, glass, nanodiamonds, or other functionalized or unfunctionalized inorganic nanoparticles having modified or unmodified surfaces. A representative amino-functionalized clay is commercially available from the Kentucky-Tennessee Clay Company of Mayfield, Ky., U.S.A. under the Amlok 321 designation. Mixtures of the nanoparticles may be utilized.

The nanoparticles of an inorganic material commonly are provided in the alkaline aqueous size composition when applied to continuous glass fibers in a concentration of 1 to 90 percent based on the total formulation solids, preferably in a concentration of 2 to 40 percent based on total formulation solids, and most preferably in a concentration of 5 to 40 percent based on total formulation solids. All percentages are based on the solids weight.

The alkaline pH of the size composition is obtained by the use of other size components, and may be adjusted so as to provide for the substantial dispersion of the nanoparticles of an inorganic material therein. The optimum alkaline pH is influenced by the alkaline contribution of the components present in the aqueous dispersion and commonly is within the range of 7.5 to 13, and preferably within the range of 8 to 11.

The remaining components of the alkaline aqueous size composition may be in accordance with previously known size compositions provided the nanoparticles of an inorganic material are compatible therewith and the resulting composition following inclusion of the inorganic nanoparticles is otherwise capable of functioning as a size for fibrous glass materials. Commonly, the aqueous size composition will also include at least one silane, at least one surfactant or lubricant, and at least one polymeric film-former.

The silanes may be of the reactive type, the non-reactive type, or a combination of reactive and non-reactive silanes. Non-reactive hydrophobic silanes are known to inhibit water adsorption at the interface between the glass fibers and a matrix. When a combination of reactive and non-reactive silanes is utilized, the relative quantities of reactive to non-reactive types commonly is in the range of 20:80 to 99:1, and most preferably in the range of 55:45 to 70:30. The silanes of the reactive type serve as coupling agents between the glass fibers and the thermoplastic matrix. The reactive silanes commonly contain a silicone head(s) and a tail(s) containing a functional group or groups that can react with the thermoplastic matrix. These include primary, secondary, or tertiary amines, vinyl, styryl, alkynyl, methacryloyl, acryloxy, epoxy, thio, sulphide, ureido, isocyanate, oxime, ester, aldehyde, and hydroxy moieties in either unprotected or protected form. The silicone head can be substituted with groups such as ethoxy, methoxy, methyldimethoxy, methydiethoxy, isopropoxy, acetoxy, etc. Representative reactive silanes include 3-aminopropyltriethoxysilane, 3-aminopropyldiethoxymethylsilane, 3-aminopropyltrimethoxysilane, N-(2-aminoethyl)-3-aminopropyltrimethoxysilane, N-(2-aminoethyl)-3-aminopropyl-methyldimethoxysilane, (3-glycidoxypropyl)trimethoxysilane, 2-(3,4-epoxycyclohexyl)ethyltrimethoxysilane, 3-isocyanotopropyltriethoxysilane, vinyltrimethoxysilane, 3-ureidopropyltrimethoxysilane, (3-aminopropyl)methyidiethoxysilane, 3-glycidopropyltriethoxysilane, vinyltriacetoxysilane, mercaptopropyltriethoxysilane, 4-amino-3,3-dimethylbutyltriethoxysilane, N-butyl-3-aminopropyltrimethoxysilane, etc. The non-reactive silanes are capable of occupying reactive sites on the glass fibers but do not otherwise chemically react with the thermoplastic polymeric matrix. The non-reactive silanes commonly include silanes that contain aliphatic, aromatic, aliphatic or aromatic fluorinated, halogen, and other functionalities. Representative non-reactive silanes include methyltrimethoxysilane, propyltriethoxysilane, propyltrimethoxysilane, 3,3,3-trifluoropropyltrimethoxysilane, iso-butyltriethoxysilane, octyltriethoxysilane, hexadecyltriethoxysilane, 1,2-bis(trimethoxysilyl)decane, etc. The silane(s) commonly are provided in the alkaline aqueous size composition in a concentration of 0.5% to 75% based on the total solids of the sizing, and preferably in a concentration of 5% to 50% based on the total solids of the size composition. A mixture of two or more silanes can be used.

A surfactant or lubricant commonly is included in the alkaline aqueous size composition to aid in the processing of the fibers during and after application of the size composition. Preferred surfactants or lubricants are the mono- or diesters of a fatty acid or oil reacted with polyethylene glycol, having hydrophilic and lipophilic areas. A preferred surfactant or lubricant of this type is Mapeg® 200 ML PEG (200) ester monolaurate that is commercially available from the BASF Corporation, Mount Olive, N.J., U.S.A. Another preferred surfactant or lubricant is Polyox WSR301 available from the Dow Chemical Company, Midland, Mich., U.S.A. Other representative surfactants or lubricants include those available under the Cat-X, Empol 1008, Pripol 1025, Emery 6717 designations. The surfactants or lubricants commonly are provided in the size composition in a concentration of approximately 0.001 to 25 percent based on the total formulation solids, and preferably in a concentration of approximately 0.001 to 10 percent based on the total formulation solids. In some cases, other sizing components may function as lubricants and/or surfactants and addition of a separate lubricant may be unnecessary.

Additionally, a polymeric film-former which is compatible with the thermoplastic matrix commonly is included in the alkaline aqueous size composition to further aid in the adherence of the nanoparticles to the glass fibers and the glass fibers to the thermoplastic matrix. Such film-formers may be of the non-ionic, cationic, or anionic types. Representative film-formers for polypropylene matrix are provided as modified polypropylene emulsions. Other polymeric matrices are typically served by emulsions of modified or unmodified urethanes, modified or unmodified polyethylenes, modified or unmodified epoxy resins, and dispersions or emulsions of other chemicals, as well as various mixtures thereof. A preferred polymeric film-former is a nonionic polypropylene grafted with maleic anhydride emulsion that is commercially available from Michelman, Inc. of Cincinnati, Ohio, U.S.A., under the Michem® ME 91735 designation. Other preferred film-formers include Neoxil 777 from DSM of Heerlen, The Netherlands, or XM10075 from Hydrosize Technologies of Raleigh, N.C., U.S.A. The film formers commonly are provided in the alkaline aqueous size in a concentration of approximately 10 to 95 percent by weight based on the total formulation solids, and preferably in a concentration of 20 to 85 percent by weight based on the total formulation solids.

The alkaline aqueous size composition optionally may include further polymeric emulsion components, adhesion promoters, solvents, emulsifiers, pigments, anti-migration aids, UV absorbers, biocides, defoaming agents, colorants, dyes, anti-static agents, antioxidants, HALS, processing aids, defoamers, antifoamers, combinations of the above and other components required or preferred for specific applications.

The glass fibers which are initially provided in continuous form commonly may be of E-glass, C-glass, A-glass, AR-glass, D-glass, R-glass, S-glass, etc., and mixtures of these. In a preferred embodiment, the continuous glass fibers are E-glass. Such glass fibers initially are supplied as long, multi-filamentary rovings or tows of infinite length. Single filaments thereof commonly possess average fiber diameters of approximately 2 to 50 μm, and preferably approximately 7 to 30 μm. It will be understood, however, that the filament diameters can be adjusted to meet the ultimate reinforcement requirements of specific end uses.

The alkaline aqueous size composition containing the nanoparticles of an inorganic material can be applied by any technique capable of well coating multi-filamentary glass fibers with the flowable size composition containing the dispersion of inorganic nanoparticles which well wets the filament surfaces. In a preferred embodiment, a kiss-roll applicator is utilized. Other equipment arrangements suitable for applying the size composition include dipping, spraying or any other protocol suitable for delivery of the size composition to the glass fibers. Commonly, the alkaline aqueous size composition possesses a viscosity of approximately 1 to 2000 MPa s, and preferably approximately 1 to 500 MPa s at the time of its application to the continuous glass fibers.

The alkaline aqueous size composition containing the nanoparticles of an inorganic material dispersed therein commonly is provided as a coating on the surfaces of the continuous glass fibers prior to removal of the aqueous phase in a concentration of approximately 0.5 to 30 percent by weight based on the formulation solids, and preferably in a concentration of approximately 1 to 20 percent by weight based on the formulation solids. One has the option of utilizing a lesser overall quantity of the alkaline aqueous size composition when compared to size compositions of the prior art. The uniform and intimate coating of the surfaces of the continuous glass fibers can be promoted by adjustment of filament contact angles, adjustment of coating roll speeds, applicator roll dimensions and/or their composition, fiber pull speeds, pressure and throughput of the pot sprays, air flow, contents of the size composition, etc.. Such parameters vary widely depending on the forming and processing needs and preferences and are known by those skilled in the art.

Next, the continuous glass fibers bearing the adhering nanoparticles of an inorganic material are cut into discontinuous lengths while retaining the roughened surfaces of the glass fibers as the result of the continued presence of the attached nanoparticles of an inorganic material. Such discontinuous lengths commonly measure approximately 2 to 100 mm, and preferably approximately 3 to 50 mm, and are well suited for serving as improved fibrous reinforcement in a thermoplastic matrix material. Any conventional fiber chopping equipment can be utilized. For instance, choppers manufactured by Finn and Fram, Inc. of San Fernando, Calif., U.S.A. can be used.

The aqueous portion of the alkaline aqueous size composition is removed and the nanoparticles of the inorganic material are caused to adhere to the surface of the glass fibers to provide finely roughened surfaces as the result of the presence of the nanoparticles of an inorganic material. Such removal of the aqueous portion of the size composition conveniently can be accomplished by volatilization in a heated oven. Representative oven temperatures commonly are approximately 50 to 300° C., and preferably approximately 100 to 250° C. Infrared or microwave power can also be utilized to dry the fibers. In such cases, the temperature may be below or above the above mentioned ranges.

Alternatively, the continuous filaments can be collected using a winder and subjected to the drying and chopping processes at later time, even immediately before the extrusion. When collecting rovings the order of the drying and the chopping steps may be reversed.

Commonly, the adhering nanoparticles are provided on the surfaces of the glass fibers in a concentration of approximately 1 to 75 percent by weight based on the weight of the total sizing solids following the removal of the aqueous component, and preferably in a concentration of approximately 10 to 40 percent by weight.

The discontinuous glass fibers having finely roughened surfaces as a result of the presence of the nanoparticles are next incorporated through blending within a thermoplastic matrix material. Such thermoplastic matrix material commonly is polymeric in nature and becomes molten when exposed to heat and returns to its original condition when cooled to room temperature. Representative thermoplastic polymeric matrix materials include melt processible polyolefins, polyesters, polyamides, polycarbonates, polyethers, liquid crystal polymers, polyethersulfones, polyphenylene oxide, polyphenylene sulfide, polybenzimidazols, thermoplastic polyurethanes, etc. Representative polyolefins include polypropylene and polyethylene. Representative polyesters include polyethylene terephthalate and polybutene terephthalate. Representative polyamides include nylon 6 and nylon 6,6. Polymers and copolymers, such as polystyrene, polymers of styrene-maleic anhydride or styrene-maleic acid, polymers of acrylonitrile-butadiene-styrene, polymers of styrene acrylonitrile, polyetheretherketones, thermoplastic polyurethanes, and polymers of acrylonitrile, when melt processible may be utilized. Blends of thermoplastic melt processible thermoplastics also can serve as the matrix material. The thermoplastic matrix material optionally can be asphalt.

A preferred thermoplastic matrix material is polypropylene homopolymer or copolymer with melt flow indices (MFI) between 1 and 100. Exemplary polypropylenes include Fortilene HB1801 from BP, Moplen HP500N from Basell, or LGF8000 from Dow Chemical. The addition of a coupling agent such as polypropylene grafted with maleic anhydride (such as Polybond 3200 from Crompton or Exxelor PP1020 from Exxon Mobil) may also be included.

The incorporation of the discontinuous glass fibers having finely roughened surfaces as the result of the presence of nanoparticles commonly may be accomplished by blending while using conventional extrusion equipment, such as twin or single-screw extruder with co- or counter-rotating screws. As a result of such blending, a material suitable for injection or compression molding is formed.

Next, fiber-reinforced thermoplastic composite articles are formed by the injection or compression molding of the thermoplastic matrix incorporating the discontinuous glass fibers having the finely roughened surfaces. During such molding step, molding temperatures are selected which correspond to a temperature at which the thermoplastic matrix is melt processable. For instance, when polypropylene of the Moplen HP500N type (Melt Flow Index of 12) is utilized as the thermoplastic polymeric matrix material, injection or compression molding temperatures of approximately 180° C. to 250° C. commonly are employed. Quality glass fiber-reinforced composite articles can be formed in a variety of configurations while using conventional injection or compression molding equipment. Representative molded articles include automotive or appliance parts, or housings, etc.

The enhancement of mechanical properties displayed by the molded articles formed in accordance with the present invention makes possible improved service qualities during use. For instance, properties such as tensile strength, notched and unnotched Izod impact strength, notched and unnotched Charpy impact strength, modulus, and flexural strength commonly are improved over similarly prepared fiber-reinforced composite articles wherein the discontinuous glass fiber reinforcement following injection or compression molding lacks roughened surfaces as the result of the presence of nanoparticles of an inorganic material which are provided as described herein. Additionally, it is found that the fiber-reinforced composite articles of the present invention commonly possess improved initial color as well as improved color following aging. It is a further economic advantage of the present invention that one has the option of utilizing a lesser overall quantity of the alkaline aqueous size composition when compared to size compositions of the prior art. The mechanism whereby the presence of the nanoparticles of an inorganic material on the discontinuous glass fibers serves to make possible such combination of benefits is considered to be complex and incapable of simple explanation. It is believed, however, that such benefits are achieved in part by improved mechanical interlocking of the discontinuous glass fibers to the thermoplastic matrix material. Also, the surface healing of minor imperfections which inherently are present in the surfaces of the discontinuous glass fibers by the nanoparticles of an inorganic material may be achieved. The mechanism whereby improved color (i.e. lower color) additionally is achieved in the resulting discontinuous fiber-reinforced composite articles is totally unknown.

The following Example is presented to provide a specific representative embodiment of the present invention. It should be understood however, that the invention is not limited to the specific details set forth in the Example.

### EXAMPLE

An alkaline aqueous dispersion of colloidal silica commercially available from Eka Chemicals, Inc. under the Bindzil® 830 designation was selected as the source of the nanoparticles of an inorganic material. Such nanoparticles were amorphous and were generally spherical in configuration, possessed a specific surface area of approximately 300 m²/g, and an average particle size of approximately 10 nm.

To 827 g of water were added under agitation 110 g of Michem® ME91735 polypropylene grafted with maleic anhydride emulsion serving as a film-former available from Michelman, Inc., 18 g of A-100 γ-aminopropyltriethoxysilane reactive silane coupling agent commercially available from GE Advanced Materials, South Charleston, W. Va., U.S.A., 1.6 grams of Mapeg® 2000 ML PEG (200) ester monolaurate surfactant or lubricant commercially available from the BASF Corporation, 43 grams of the alkaline aqueous dispersion of silica nanoparticles, and 0.1 gram of DEE FO PI-35 polysiloxane-based deformer provided in neat form and commercially available from Ultra Additives of Bloomfield, N.J., U. S. A. The resulting aqueous size composition possessed an alkaline pH of 10.5. The silica nanoparticles present in the alkaline aqueous size composition had a concentration of approximately 20 percent, the polymeric film-former was provided in a concentration of approximately 60 percent, the reactive silane coupling agent was provided in an effective concentration of approximately 18 percent achieved after in-situ hydrolysis, and the surfactant and deformer were provided in a total concentration of approximately 2 percent; all based by weight on total solids in the composition.

A kiss-roll applicator with a circumference of 45 cm operating at a speed of approximately 40 revolutions per minute was used to apply as an intimate coating the alkaline aqueous size composition containing the dispersion of silica nanoparticles to a roving of E-glass. The roving consisted of approximately 4,000 continuous glass filaments each having an average single filament diameter of approximately 13.5 μm.

The glass continuous fibers roving bearing such nanoparticles on the filament surfaces was passed at a rate of approximately 20 meters per second to a chopper operating at a rate of approximately 130 cuts per second to form modified discontinuous glass fibers while retaining the presence of the nanoparticles on the glass fiber surfaces. The resulting discontinuous fibers were cut to average lengths of approximately 5 mm.

The resulting chopped glass fibers bearing a coating of the aqueous alkaline size composition were passed through an oven set at 190° C. where the aqueous portion of the composition was removed through volatilization resulting in the further adherence of the silica nanoparticles to the surfaces of the continuous glass filaments of roving to yield finely roughened filament surfaces as the result of the presence of the nanoparticles. Following such drying, the silica nanoparticles were present in the sized fibreglass in a concentration of 20 percent by weight based on the weight of the total sizing solids.

The discontinuous glass fibers having finely roughened surfaces as the result of the presence of the nanoparticles following drying were incorporated through blending in a polypropylene thermoplastic matrix material by extrusion using a twin-screw extruder. The polypropylene matrix material was of a polypropylene homopolymer with Melt Flow Index of 12, and was commercially available from Basell of Frankfurt, Germany, under the Moplen HP500N designation.

Pellets of the matrix material suitable for melt processing having dimensions of approximately 2 mm to 5 mm were formed from the resulting blend by the use of a standard pelletizer. Such pellets then were injection molded using a molding machine at a temperature of approximately 200° C. to form discontinuous fiber-reinforced composite articles. Any extruder, pelletizer, or other molding machines for thermoplastic materials can be used for such molding.

The resulting injection molded articles were subjected to physical testing and their properties were compared to similarly prepared fiber-reinforced composite articles in which nanoparticle roughening was absent on the discontinuous fiber surfaces. A comparison of the physical properties is set forth in the Table which follows.

TABLE

| | With | Without |
|---|---|---|
| Property | Nanoparticles | Nanoparticles |
| Fiber Diameter | 13.6 μm | 13.5 μm |
| Loss on Ignition (LOI) | 0.57% | 0.66% |
| Tensile Strength-Initial | 76 MPa | 72 MPa |
| (ASTM D638) | | |
| Tensile Strength With Aging | 57 MPa | 57 MPa |
| (10 days in 95° C. water) | | |
| Flexural Modulus | 3.8 GPa | 3.8 GPa |
| (ASTM D790) | | |
| Yield | 198 MPa | 182 MPa |
| Flexural Strength | 122 MPa | 112 MPa |
| (ASTM D790) | | |
| Initial Color | 7.1 | 10.4 |
| (Using Colorimeter) | | |
| Color With Aging | 8.7 | 13.3 |
| (24 h at 150° C.) | | |
| Unnotched Charpy Impact | 113 kJ/m² | 90 kJ/m² |
| (ASTM D6110) | | |
| Notched Charpy Impact | 21 kJ/m² | 17 kJ/m² |
| Unnotched Izod Impact | 637 J/m | 613 J/m |
| (ASTM D256) | | |
| Notched Izod Impact | 196 J/m | 184 J/m |

As indicated above, a number of physical properties in the resulting injection molded discontinuous fiber-reinforced composition articles including color were enhanced when practicing the present invention. Both the product of the present invention and that obtained using the control size yielded good strand integrity.

The principles, preferred embodiments, and modes of operation of the present invention have been described in the foregoing specification. The invention which is protected herein, however, is not to be construed as being limited to the particular forms disclosed, since these are to be regarded as being illustrative rather than restrictive. Variations and changes may be made by those skilled in the art without departing from the spirit of the invention.

We claim:

1. A process for forming discontinuous modified glass fibers suitable for incorporation in a thermoplastic matrix and the formation of a fiber-reinforced composite article by injection or compression molding which displays enhanced mechanical properties comprising:
(a) adhering nanoparticles of an inorganic material that are dispersed in an alkaline aqueous size composition to the surfaces of glass fibers, which are present in continuous form to provide finely roughened surfaces on said continuous glass fibers as the result of the presence of said nanoparticles of said inorganic material,
(b) cutting said continuous glass fibers into discontinuous lengths while retaining said roughened surfaces on said glass fibers as the result of the presence of said nanoparticles of said inorganic material, and
(c) drying said discontinuous glass fibers while retaining said roughened surfaces on said glass fibers.

2. A process for forming discontinuous glass fibers suitable for incorporation in a thermoplastic matrix according to claim 1, wherein said continuous glass fibers of step (a) are selected from the group consisting of E-glass, C-glass, A-glass, AR-glass, D-glass, R-glass, S-glass, and mixtures of the foregoing, and possess a diameter of approximately 2 to 50 microns.

3. A process for forming discontinuous glass fibers suitable for incorporation in a thermoplastic matrix according to claim 1, wherein said continuous glass fibers of step (a) are E-glass, and possess a diameter of approximately 7 to 30 microns.

4. A process for forming discontinuous glass fibers suitable for incorporation in a thermoplastic matrix according to claim 1, wherein said alkaline aqueous dispersion possesses a pH of approximately 8 to 11.

5. A process for forming discontinuous glass fibers suitable for incorporation in a thermoplastic matrix according to claim 1, wherein said nanoparticles of an inorganic material possess an average particle size of approximately 3 to 40 nm.

6. A process for forming discontinuous glass fibers suitable for incorporation in a thermoplastic matrix according to claim 1, wherein said nanoparticles of an inorganic material possess an average particle size of approximately 3 to 10 nm.

7. A process for forming discontinuous glass fibers suitable for incorporation in a thermoplastic matrix according to claim 1, wherein said nanoparticles of an inorganic material are selected from the group consisting of silica, clay, glass, nanodiamonds, and mixtures of the foregoing.

8. A process for forming discontinuous glass fibers according to claim 1, wherein said nanoparticles of an inorganic material are silica.

9. A process for forming discontinuous glass fibers according to claim 1, wherein said alkaline size composition of step (a) additionally includes silane, surfactant, and polymeric film-former.

10. A process for forming discontinuous glass fibers according to claim 1, wherein in step (a) the nanoparticles of said inorganic material are caused to adhere to said continuous glass fibers by initially coating said alkaline aqueous size composition on the surfaces of said glass fibers followed by heating to remove water through volatilization.

11. A process for forming discontinuous glass fibers according to claim 1, wherein in step (b) said continuous glass fibers are cut into discontinuous lengths of approximately 2 to 100 mm.

12. A process for forming discontinuous glass fibers according to claim 1, wherein in step (b) said continuous glass fibers are cut into discontinuous lengths of approximately 3 to 50 mm.

13. Surface-modified discontinuous glass fibers suitable for incorporation in a thermoplastic matrix and the formation of a fiber-reinforced composite article by injection or compression molding which displays enhanced mechanical properties as the result of surface roughening created by the presence of said adhering nanoparticles of an inorganic material formed by the process of claim 1.

14. A process for forming a discontinuous glass fiber-reinforced thermoplastic composite article comprising:
(a) adhering nanoparticles of an inorganic material that are dispersed in an alkaline aqueous size composition to the surfaces of glass fibers which are present in continuous form to provide finely roughened surfaces on said continuous glass fibers as the result of the presence of said nanoparticles of said inorganic material,
(b) cutting said continuous glass fibers into discontinuous lengths while retaining said roughened surfaces on said glass fibers as the result of the presence of said nanoparticles of said inorganic material,
(c) extruding the discontinuous glass fibers having said finely roughened surfaces together with a thermoplastic wherein the surface-attached nanoparticles of inorganic material serve to promote the secure bonding of the discontinuous glass fibers within said thermoplastic matrix to form a material suitable for molding, and
(d) injection or compression molding said material incorporating said discontinuous glass fibers having said finely roughened surfaces to form a fiber-reinforced composite article which displays enhanced mechanical properties.

15. A process for forming a discontinuous glass fiber-reinforced thermoplastic composite article according to claim 14, wherein said continuous glass fibers of step (a) are selected from the group consisting of E-glass, C-glass, A-glass, AR-glass, D-glass, R-glass, S-glass, and mixture of the foregoing, and possess a diameter of approximately 2 to 50 microns.

16. A process for forming a discontinuous glass fiber-reinforced thermoplastic composite article according to claim 14, wherein said continuous glass fibers of step (a) are E-glass, and possess a diameter of approximately 7 to 30 microns.

17. A process for forming a discontinuous glass fiber-reinforced thermoplastic composite article according to claim 14, wherein said alkaline aqueous dispersion possesses a pH of approximately 8 to 11.

18. A process for forming a discontinuous glass fiber-reinforced thermoplastic composite article according to claim 14, wherein said nanoparticles of an inorganic material possess an average particle size of approximately 3 to 40 nm.

19. A process for forming a discontinuous glass fiber-reinforced thermoplastic composite article according to claim 14, wherein said nanoparticles of an inorganic material possess an average particle size of approximately 3 to 10 nm.

20. A process for forming a discontinuous glass fiber-reinforced thermoplastic composite article according to claim 14, wherein said nanoparticles of an inorganic material are selected from the group consisting of silica, clay, glass, nanodiamonds, and mixtures of the foregoing.

21. A process for forming a discontinuous glass fiber-reinforced thermoplastic composite article according to claim 14, wherein said nanoparticles of an inorganic material are silica.

22. A process for forming a discontinuous glass fiber-reinforced thermoplastic composite article according to claim 14, wherein said alkaline size composition of step (a) additionally includes silane, surfactant, and polymeric film-former.

23. A process for forming a discontinuous glass fiber-reinforced thermoplastic composite article according to claim 14, wherein in step (a) the nanoparticles of said inorganic material are caused to adhere to said continuous glass fibers by initially coating said alkaline aqueous size composition on the surfaces of said glass fibers followed by heating to remove water through volatilization.

24. A process for forming a discontinuous glass fiber-reinforced thermoplastic composite article according to claim 14, wherein in step (b) said continuous glass fibers are cut into discontinuous lengths of approximately 2 to 100 mm.

25. A process for forming a discontinuous glass fiber-reinforced thermoplastic composite article according to claim 14, wherein in step (b) said continuous glass fibers are cut into discontinuous lengths of approximately 3 to 50 mm.

26. A process for forming a discontinuous glass fiber-reinforced thermoplastic composite article according to claim 14, wherein said thermoplastic of step (c) is selected from the group consisting of polyolefins, polyesters, polyamides, polycarbonates, polyethers, liquid crystal polymers, polyethersulfones, polyphenylene oxide, polyphenylene sulfide, polybenzimidazoles, thermoplastic polyurethanes, and blends of the foregoing.

27. A process for forming a discontinuous glass fiber-reinforced thermoplastic composite article according to claim 14, wherein said thermoplastic is polypropylene.

28. A discontinuous glass fiber-reinforced thermoplastic composite article formed by the process of claim 14, which displays enhanced mechanical properties following injection or compression molding as the result of discontinuous glass fiber reinforcement having finely roughened surfaces on said discontinuous glass fibers as the result of the presence of said adhering nanoparticles of an inorganic material.
